(19) United States
(12) Patent Application Publication
(10) Pub. No.: US 2019/0057384 A1
(43) Pub. Date: Feb. 21, 2019

(54) GENERATING ROLLBACK REQUESTS TO REVERSE PARTIALLY APPROVED PAYMENTS

(71) Applicant: Amadeus S.A.S., Biot (FR)

(72) Inventors: Rajat Hubli, Somerville, MA (US); Daniel Sastre Garcia, Cambridge, MA (US)

(21) Appl. No.: 15/679,735

(22) Filed: Aug. 17, 2017

(51) Int. Cl. G06Q 20/40; G06Q 20/22; G06Q 10/02; G06Q 30/02

(52) U.S. Cl. CPC G06Q 20/407; G06Q 20/227; G06Q 30/0233; G06Q 10/02; G06Q 20/405

(57) ABSTRACT

Methods, systems, and computer program products that generate a rollback request. The system receives information indicating a first form of payment, a first transaction to the first form of payment, information indicating a second form of payment, and a second transaction to the second form of payment that are collectively used to purchase a product or service. The system sends a first request to authorize the first transaction to the first form of payment to a first payment provider system. The system receives a first notification that the first request has been approved by the first payment provider system. The system sends a second request to authorize the second transaction to the second form of payment to a second payment provider system. In response to detecting a failure of the second request, the system determines whether the first form of payment is capable of being reversed or refunded.

### TECHNICAL FIELD

The invention generally relates to computers and computer software, and in particular to methods, systems, and computer program product systems that generate rollback requests to reverse partially approved payments.

### BACKGROUND

Computer technology is increasingly used in the travel industry to manage, support, book, reserve, and process travel reservations as well as data associated therewith. One aspect of these systems is related to purchasing and issuing various travel reservations. For example, a traveler may purchase a seat for a flight on an aircraft using a particular form of payment. The form of payment may be, for example, a credit card, a debit card, loyalty account points, a digital wallet, or an alternative method of payment such as online payment systems.

Sometimes a travel reservation may be purchased using a single form of payment. When using this approach, the entire price of the reservation is paid using only one form of payment. Alternatively, a traveler may pay for a travel reservation using multiple forms of payment. Specifically, each form of payment may be used to pay for a portion of the total price of the travel reservation. For example, a traveler may pay for an airline ticket using a combination of loyalty account points and multiple credit cards. However, in some situations when two or more forms of payments are used to pay for a reservation, at least one transaction relating to one of the form of payments fails. The form of payment may fail for a variety of different reasons. For example, the form of payment may fail due to insufficient funds in a bank account if a debit card is being used. The form of payment may also fail if there are issues connecting to the network to verify payment.

If even one form of payment fails, then the entire payment transaction as a whole is considered incomplete. As a result, the travel reservation will not be booked, even if the traveler has already paid for a portion of the purchase price. For example, the traveler may pay for a portion of an airline ticket using his or her loyalty account points. However, the credit card being used for the remaining portion of the purchase price of the airline ticket is declined. Thus, even though the traveler has paid for a portion of the airline ticket using his or her loyalty points, the airline ticket is not booked.

If a travel reservation is not booked because one or more forms of payments have failed, then a travel representative may need to troubleshoot the payment transaction. It may be especially difficult for a travel agent or representative to determine why a particular transaction failed, as there are usually multiple channels through which a payment is processed. For example, a credit card transaction may involve a payer, an issuing bank, a payment provider, and an acquirer.

Thus, improved methods, systems, and computer program products to book products and services are needed.

### SUMMARY

In an embodiment of the invention, a system for generating a rollback request is provided. The system receives information indicating a first form of payment, a first transaction to the first form of payment, information indicating a second form of payment, and a second transaction to the second form of payment that are collectively used to purchase a product or service. The system sends a first request to authorize the first transaction to the first form of payment to a first payment provider system. The system receives a first notification that the first request has been approved by the first payment provider system. The system sends a second request to authorize the second transaction to the second form of payment to a second payment provider system. The system detects a failure of the second request. In response to detecting the failure of the second request, the system determines whether the first form of payment is capable of being reversed or refunded based on business rules. In response to determining that the first transaction to the first form of payment is capable of being reversed or refunded, the system sends a first rollback request to the first payment provider with instructions to reverse or refund the first transaction.

In one embodiment, the system includes program code that, when executed by the one or more processors, further causes the system to receive information indicating a third form of payment and a third transaction to the third form of payment used to purchase the product or service. The system is further caused to send, to a third payment provider system, a third request to authorize the third transaction to the third form of payment. The system also receives a second notification that the third request has been approved by the third payment provider system.

In another embodiment, the system includes program code that, when executed by the one or more processors, further causes the system to send a second rollback request to the third payment provider with instructions to reverse or refund the third transaction. The first rollback request and the second rollback request occur asynchronously with respect to one another.

In yet another embodiment, the first rollback request and the second rollback request are placed in a processing queue, and the first rollback request is removed from the processing queue after receiving a reverse or refund notification.

In another embodiment, a refund notification is not received in reply to the first rollback request over a predetermined amount of time, and the program code further causes the system to periodically send a predetermined number of secondary requests for reversal or refund of the first transaction to the first payment provider at predetermined intervals of time.

In one embodiment, the system includes program code that, when executed by the one or more processors, further causes the system to place the first transaction into a timeout exception queue in response to the predetermined number of the secondary requests failing to result in receipt of a reverse or refund notification.

In another embodiment, the instructions for the first rollback request include an instruction to reverse the first transaction.

In yet another embodiment, the instructions for the first rollback request include an instruction to refund the first transaction.

In another embodiment, the system includes program code that, when executed by the one or more processors, further causes the system to receive a second notification from the second payment provider that the second request has been denied by the second payment provider.

In yet another embodiment, a method of generating a rollback request is provided. The method includes receiving, by a computer, information indicating a first form of payment, a first transaction to the first form of payment, information indicating a second form of payment, and a second transaction to the second form of payment that are collectively used to purchase a product or service. The method further includes sending, by the computer, a first request to authorize the first transaction to the first form of payment to a first payment provider system. The method also includes receiving a first notification that the first request has been approved by the first payment provider system. The method includes sending, by the computer, a second request to authorize the second transaction to the second form of payment to a second payment provider system. The method also includes detecting a failure of the second request. In response to detecting the failure of the second request, the method includes determining, by the computer, whether the first transaction to the first form of payment is capable of being reversed or refunded based on business rules. In response to determining that the first transaction to the first form of payment is capable of being reversed or refunded, the method includes sending a first rollback request, by the computer, to the first payment provider with instructions to reverse or refund the first transaction.

In another embodiment of the invention, a computer program product is provided for selecting a travel record associated with a user profile, the computer program product comprising a non-transitory computer-readable storage medium and program code stored on the non-transitory computer-readable storage medium that, when executed by one or more processors, causes the one or more processors to receive information indicating a first form of payment, a first transaction to the first form of payment, information indicating a second form of payment, and a second transaction to the second form of payment that are collectively used to purchase a product or service. The processor sends a first request to authorize the first transaction to the first form of payment to a first payment provider system. The processor receives a first notification that the first request has been approved by the first payment provider system. The processor sends a second request to authorize the second transaction to the second form of payment to a second payment provider system. The processor detects a failure of the second request. In response to detecting the failure of the second request, the processor determines whether the first form of payment is capable of being reversed or refunded based on business rules. In response to determining that the first transaction to the first form of payment is capable of being reversed or refunded, the processor sends a first rollback request to the first payment provider with instructions to reverse or refund the first transaction.

The various embodiments of the invention may increase the efficiency of processing data by computer-based devices and may also improve computer-related technology by allowing computer performance of a function not previously performable by a computer.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention. In the drawings, like reference numerals are used to indicate like parts in the various views.

FIG. 1 is a diagrammatic view of an exemplary operating environment including a merchant system, a payment server, and at least one payment provider for generating a rollback request that reverses an approved form of payment.

FIG. 2 is a diagrammatic view of an exemplary computer system of FIG. 1.

FIG. 3 is a diagrammatic view of the merchant system, the payment server, and the payment providers shown in FIG. 1.

FIG. 4 is a flowchart that may be executed by the payment server of FIG. 3 to generate a rollback request that reverses an approved form of payment.

### DETAILED DESCRIPTION

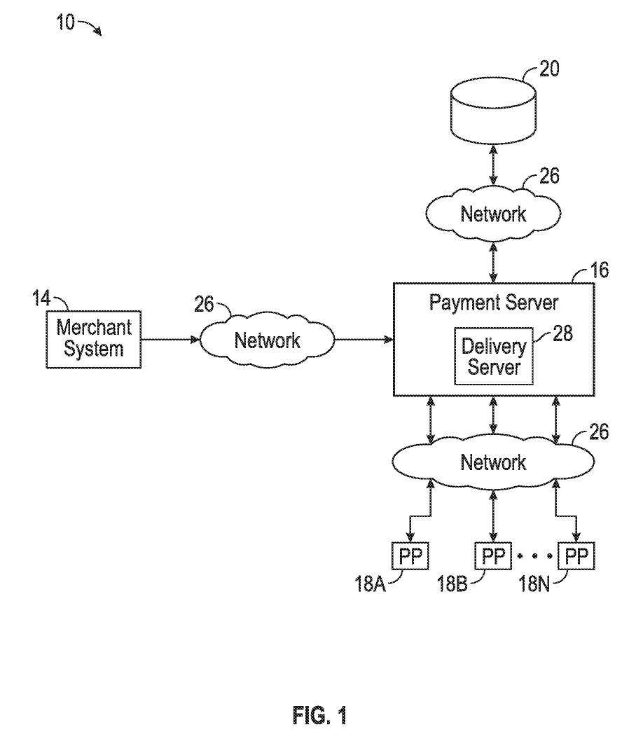

Referring now to FIG. 1, an operating environment 10 in accordance with an embodiment of the invention may include a merchant system 14, a payment server 16, and at least one payment provider 18A-18N. The payment server 16 is in communication with the merchant system 14, the payment providers 18, and a database 20 for storing one or more business rules. Each of the merchant system 14, the payment server 16, the payment providers 18, and the database 20 may communicate through a network 26. The network 26 may include one or more private or public networks (e.g., the Internet) that enable the exchange of data.

The merchant system 14 may provide users (e.g., travel agents) with an interface for accessing a Global Distribution System (GDS) that enables the users to search for and book services. The merchant system 14 may also include a server application accessible by a traveler system (not shown) that enables the traveler to search for and book travel itineraries without the help of a travel agent. This application may comprise, for example, a travel-related website that is accessible over the network 26 using a client application such as a web-browser running on the traveler system.

The payment server 16 receives an authorization request from the merchant system 14 through the network 26 to purchase products or book services. In one non-limiting embodiment, the authorization request may propose to book one or more travel-related services such as airline tickets, hotel reservations, or a car rental using at least two forms of payment. However, it is to be appreciated that the disclosed payment server 16 is not limited to booking only travel-related services, and a variety of other products or services may be purchased as well. In the examples as disclosed, more than one form of payment is used to pay for a particular product or service. Some examples of forms of payment include, but are not limited to, a credit card, a debit card, loyalty account points, a digital wallet, or an alternative method of payment such as online payment systems.

In response to receiving the authorization request to book services, the payment server 16 may then send the authorization request to at least one payment provider 18A-18N over the network 26. Each payment provider system 18 may correspond to a particular form of payment. For example, a payment provider system 18A may correspond to a particular credit card company, while a payment provider system 18B may correspond to a specific bank for authorizing a debit card. In response to receiving the approval request, each of the payment providers 18 may either authorize or decline the corresponding form of payment indicated by the authorization request.

The payment server 16 also includes a delivery server 28. As explained in greater detail below, the delivery server 28 may be used to reverse or refund a successful transaction in some circumstances. In particular, two or more forms of payments may be used to pay for booking a specific service. The payment server 16 detects at least one successful transaction and a failure of at least one of the forms of payment, and the delivery server 28 seeks to reverse any successful transactions. In other words, any form of payment that has already been approved is reversed, if possible. Specifically, the delivery server 28 may first determine if the particular form of payment that has already been approved is eligible to be reversed or refunded. This determination may be based on business rules stored in the database 20. If the form of payment is eligible for reversal or refund, then the delivery server 28 may send a rollback request to each payment provider system 18 that has already approved a form of payment to purchase the specific service.

The form of payment may fail for any number of reasons. For example, in one embodiment the transaction may fail because the payment server 16 was unable to connect to the corresponding payment provider system 18 due to poor connectivity of the network 26. Thus, the payment server 16 may detect failure of the transaction if a notification has not been received within a predetermined amount of time. In yet another embodiment, the transaction may fail because the form of payment has been denied. For example, a transaction may be denied if there are insufficient funds in a bank account if a debit card is used. Thus, the payment server 16 may detect failure of the transaction based on receiving a failure notification from a corresponding payment server 16. In another example, the transaction may be denied if the form of payment has expired. For example, a user may inadvertently use an expired credit card to pay for a booking. Accordingly, the delivery server 28 may detect failure of the transaction based on receiving a notification that the credit card has expired.

A reversal of payment typically means that the funds in a particular account are removed from hold, and any authorization to place a hold on the funds is canceled. A refund typically means that any funds that were previously paid are now transferred back to a user's account. In one embodiment, the funds may represent money. In another embodiment, the funds may represent alternative forms of money that may be used to purchase products or services such as, but not limited to, credit card points or airline miles.

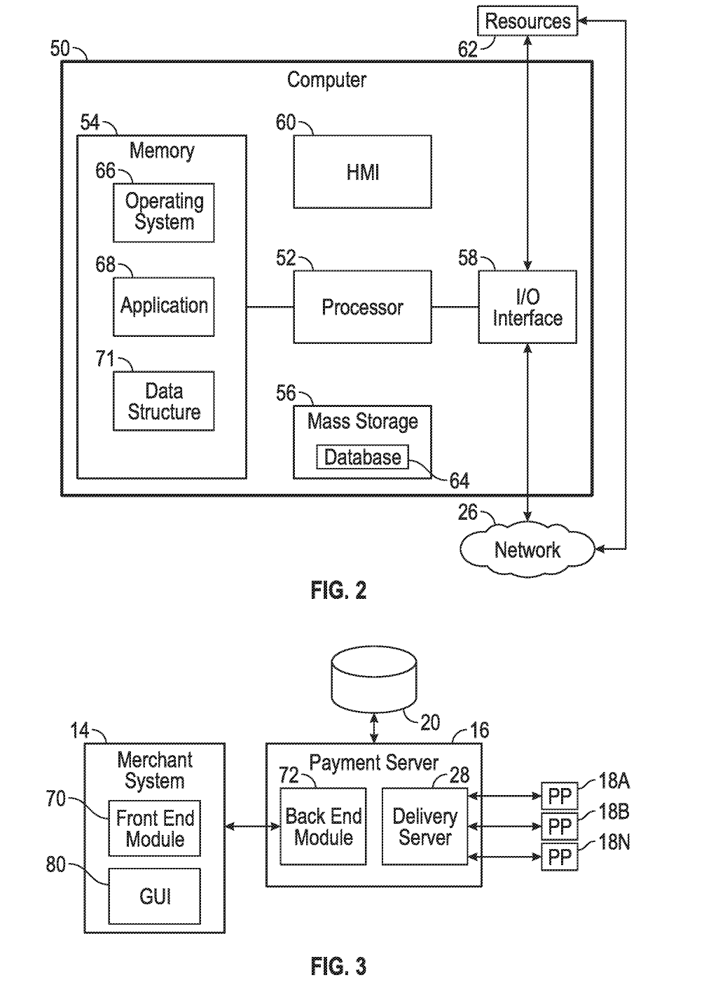

Referring now to FIG. 2, the merchant system 14, the payment server 16, and the payment providers 18 of the operating environment 10 may be implemented on one or more computer devices or systems, such as exemplary computer system 50. The computer system 50 may include a processor 52, a memory 54, a mass storage memory device 56, an input/output (I/O) interface 58, and a Human Machine Interface (HMI) 60. The computer system 50 may also be operatively coupled to one or more external resources 62 via the network 26 or I/O interface 58. External resources may include, but are not limited to, servers, databases, mass storage devices, peripheral devices, cloud-based network services, or any other suitable computer resource that may be used by the computer system 50.

The processor 52 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 54. Memory 54 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 56 may include data storage devices such as a hard drive, optical drive, tape drive, volatile or non-volatile solid state device, or any other device capable of storing information.

The processor 52 may operate under the control of an operating system 66 that resides in memory 54. The operating system 66 may manage computer resources so that computer program code embodied as one or more computer software applications, such as an application 68 residing in memory 54, may have instructions executed by the processor 52. In an alternative embodiment, the processor 52 may execute the application 68 directly, in which case the operating system 66 may be omitted. One or more data structures 71 may also reside in memory 54, and may be used by the processor 52, operating system 66, or application 68 to store or manipulate data.

The I/O interface 58 may provide a machine interface that operatively couples the processor 52 to other devices and systems, such as the network 26 or external resource 62. The application 68 may thereby work cooperatively with the network 26 or external resource 62 by communicating via the I/O interface 58 to provide the various features, functions, applications, processes, or modules comprising embodiments of the invention. The application 68 may also have program code that is executed by one or more external resources 62, or otherwise rely on functions or signals provided by other system or network components external to the computer system 50. Indeed, given the nearly endless hardware and software configurations possible, persons having ordinary skill in the art will understand that embodiments of the invention may include applications that are located externally to the computer system 50, distributed among multiple computers or other external resources 62, or provided by computing resources (hardware and software) that are provided as a service over the network 26, such as a cloud computing service.

The HMI 60 may be operatively coupled to the processor 52 of computer system 50 in a known manner to allow a user to interact directly with the computer system 50. The HMI 60 may include video or alphanumeric displays, a touch screen, a speaker, and any other suitable audio and visual indicators capable of providing data to the user. The HMI 60 may also include input devices and controls such as an alphanumeric keyboard, a pointing device, keypads, pushbuttons, control knobs, microphones, etc., capable of accepting commands or input from the user and transmitting the entered input to the processor 52.

A database 64 may reside on the mass storage memory device 56, and may be used to collect and organize data used by the various systems and modules described herein. The database 64 may include data and supporting data structures that store and organize the data. In particular, the database 64 may be arranged with any database organization or structure including, but not limited to, a relational database, a hierarchical database, a network database, or combinations thereof. A database management system in the form of a computer software application executing as instructions on the processor 52 may be used to access the information or data stored in records of the database 64 in response to a query, where a query may be dynamically determined and executed by the operating system 66, other applications 68, or one or more modules.

Referring now to FIG. 3, in an exemplary embodiment of the disclosure the merchant system 14 may include a front end module 70, and the payment server 16 may include a back end module 72 and the delivery server 28. The front end module 70 of the merchant system 14 may be in communication with the back end module 72 of the payment server 16. The payment server 16 may be in communication with at least one payment provider 18A-18N. The modules 70, 72 are shown as distinct components, which may indicate the use of modular programming techniques. However, the software design may decrease the extent to which the modules 70, 72 are distinct by combining at least some program functions of multiple modules into a single module. Moreover, those of ordinary skill in the art will readily understand that the functions attributed to the modules 70, 72 may be distributed in other ways, or on other systems than those depicted. Thus, embodiments of the invention are not limited to the specific arrangement of systems or modules shown in FIG. 3.

The merchant system 14 includes a graphical-user-interface (GUI) 80 that may be accessed by a user, such as a travel agent. The user may enter input using the GUI 80 of the merchant system 14. Specifically, the input entered by the user indicates a specific request to purchase products or book services. In the exemplary embodiment as described, the specific request is to book travel-related services. The input may also indicate two or more forms of payment used to book the travel-related services. The merchant system 14 may then initiate an authorization process to approve the forms of payment used to book the services. Specifically, the front end module 70 of the merchant system 14 generates an authorization request in response to receiving the input by the GUI 80. The authorization request may represent a request to book services using two or more forms of payment.

In one illustrative example, the authorization request may include a request to book airline tickets for a particular flight. The authorization request may also include three forms of payment, namely loyalty account points, a first credit card, and a second credit card. In one embodiment, the loyalty account points may be airline miles, which are also referred to as frequent flyer miles or travel points. Airline miles are typically part of a loyalty program offered by airlines and/or credit cards, where a user may accumulate a set number of miles based on how far he or she flies, or how much he or she spends on a credit card. The user may then use the miles to buy airline tickets. However, the loyalty points included by the authorization request are not sufficient to pay for the entire cost of the airline tickets. Therefore, the first and second credit cards are used to pay for the remaining cost of the airline ticket. Specifically, each credit card may be used to pay for half of the remaining cost of the airline ticket.

Continuing to refer to FIG. 3, the front end module 70 of the merchant system 14 may send the authorization request to the back end module 72 of the payment server 16. Alternatively, in another embodiment, the front end module 70 of the merchant system 14 may send the authorization request directly to the payment server 16. In response to receiving the authorization request, the payment server 16 may perform an authorization process to validate each form of payment included by the authorization request. Specifically, the payment server 16 authorizes multiple transactions, where each transaction corresponds to one of the forms of payment included in the authorization request.

In the illustrative example as described, a payment provider system 18A may correspond to the loyalty points, a payment provider system 18B may correspond to the first credit card, and a payment provider system 18N may correspond to the second credit card. It is to be appreciated that although the present example includes three forms of payment, the disclosed payment system is not limited to only three forms of payment. Indeed, the payment server 16 may receive any number of forms of payment from the merchant system 14. Furthermore, although three payment provider systems 18A, 18B, and 18N are illustrated in FIG. 3, any number of payment systems may be in communication with the payment server 16.

The payment server 16 may generate a first request to authorize a first transaction corresponding to the loyalty points to the payment provider system 18A. The payment server 16 may then receive a first notification that the loyalty points have been approved by the payment provider system 18A. Similarly, the payment server 16 may send a second request to the payment provider system 18B to authorize a second transaction to approve the first credit card. However, the first credit card that corresponds to the payment provider system 18N may fail. As mentioned above, a form of payment may fail for any number of reasons. In the present example, the first credit card is expired. Accordingly, the payment server 16 detects failure of the second transaction based on receiving a notification that the first credit card is expired. The payment server 16 may also generate a request to the payment provider system 18N to authorize the second credit card. The payment server 16 may then receive a second notification that the second credit card has been approved.

In the event one of the transactions for a form of payment has failed, then the payment server 16 first determines if all of the previously approved transactions are eligible to be refunded or reversed. In one embodiment, the rules database 20 may store payment provider capabilities for each available payment provider. Specifically, capabilities for each payment provider include an indication if a transaction corresponding to a form of payment may be refunded or reversed. Accordingly, in response to receiving a notification that a transaction has failed, the payment server 16 may search the database 20 for business rules corresponding to the specific payment provider for the approved transactions. The payment server 16 then determines if a transaction corresponding to a particular form of payment may either be reversed or refunded based on the business rules stored in the rules database 20.

In response to determining that the transaction corresponding to the failed form of payment is capable of being reversed or refunded, the delivery server 28 determines if there is at least one transaction corresponding to a form of payment that has already been approved. The delivery server 28 may then generate one or more rollback requests. Specifically, a rollback request is generated and sent to a particular payment provider system 18 for each transaction corresponding to a form of payment that was already approved.

It is to be appreciated that each rollback request may be sent to a corresponding one of the payment providers 18 in an asynchronous manner. In other words, the rollback requests may occur asynchronously with respect to one another. In one embodiment, multiple rollback requests may be sent from the delivery server 28 at about the same time, and are each sent to a corresponding payment provider system 18. Thus, it is to be appreciated that one of the rollback requests is not dependent on the response time of another rollback request.

In one embodiment, the delivery server 28 may determine one or more processing queues. Specifically, if a transaction indicating a form of payment has failed, and if two or more forms of payment have already been approved, then the delivery server 28 may determine one or more processing queues. A processing queue may include one or more rollback requests that each correspond to an approved form of payment. For example, in the event the loyalty points as well as the second credit card were both approved, but the first credit card was declined, then the delivery server 28 would create two rollback requests. The loyalty points could correspond to a first rollback request, and the second credit card transaction could correspond to a second rollback request. Both the first rollback request and the second rollback request may be placed into respective processing queues.

There may be separate processing queues for each specific type of merchant, as well as separate processing queues based on whether the the form of payment is reversed or refunded. For example, the first rollback request corresponding to the loyalty points may be refunded back to the user's account, and is placed into a first processing queue. Similarly, the second rollback request corresponding to the first credit card may be reversed, and is placed into a second processing queue. In one embodiment, each processing queue may either refund or reverse each transaction based on a first-in, first-out (FIFO) approach, meaning that the oldest rollback requests are sent to a specific payment provider first.

The delivery server 28 may remove a rollback request from the processing queue after receiving a corresponding reversal or refund notification from the respective payment provider system 18. For example, in response to receiving a notification from the payment provider system 18A that the loyalty points have been refunded back to the user's airline miles account, the payment provider system 18A may then remove the first rollback request from the first processing queue.

In at least some instances, a reversal or refund notification may not be received by the delivery server 28 within a predetermined amount of time. The predetermined amount of time starts as soon as the delivery server 28 sends the rollback request to the corresponding payment server 16. If the refund notification is not received within the predetermined amount of time, then the payment server 16 may periodically send secondary requests in an attempt to reverse or refund the transaction corresponding to the particular payment provider system 18. The payment server 16 may continue to send a predetermined number of secondary requests to the particular payment provider system 18 at predetermined intervals of time. For example, in one embodiment, the payment server 16 may send ten secondary requests to a particular payment provider system 18, where each secondary request is sent in ten second intervals. However, if the payment server 16 does not receive the refund notification after the predetermined number of secondary requests have been sent, then the payment server 16 may place the rollback request into a timeout exception queue.

The rollback requests placed into the timeout exception queue require manual action. This means that the rollback requests in the timeout exception queue may not be handled by a user such as a travel agent. Instead, technical personnel may address the rollback requests. Specifically, as soon as a rollback request is introduced to the timeout exception queue, a notification may be displayed upon a monitoring interface, such as a graphical user interface (GUI) used by the technical personnel (not illustrated in the figures). Once the number of rollback requests exceeds a predetermined limit in the timeout exception queue, then a trigger or alarm may be raised to notify the technical personnel. In one example, the alarm may be raised as soon as there are five rollback requests in the timeout exception queue.

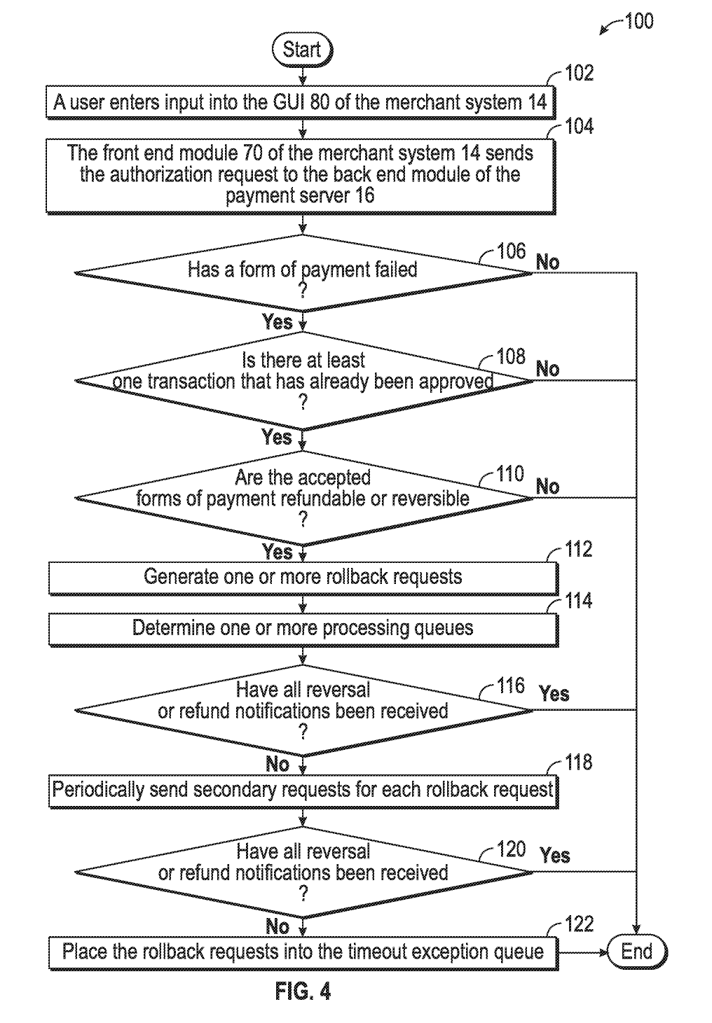

Turning now to FIG. 4, a flowchart that depicts a process 100 may be performed by the front end module 70 of the merchant system 14, the back end module 72 of the payment server 16, and the delivery server 28 of the payment server 16, to perform one or more rollback requests.

Referring to both FIGS. 3 and 4, the process 100 may begin at block 102. In block 102 the user enters input into the GUI 80 of the merchant system 14. Specifically, as explained above, the input indicates a specific request to book one or more services or products, as well as two or more forms of payment to pay for the services or the products. The merchant system 14 may then initiate an authorization process to approve the two or more forms of payment. The process 100 may then proceed to block 104.

In block 104, the front end module 70 of the merchant system 14 sends the authorization request to the back end module 72 of the payment server 16. Alternatively, in another embodiment, the front end module 70 of the merchant system 14 may send the authorization request directly to the payment server 16. In response to receiving the authorization request, the payment server 16 may then perform an authorization process in order to validate the forms of payment indicated by the authorization request. The process 100 may then proceed to block 106.

In decision block 106, the payment server 16 detects if one of the transactions for a form of payment has failed. If none of the forms of payment fail, then the process 100 may terminate. However, if the payment server 16 determines that one or more transactions corresponding to one of the forms of payment has failed, then the process 100 may proceed to block 108.

In block 108, the delivery server 28 determines if there is at least one transaction corresponding to a form of payment that has already been approved. If there are no transactions corresponding to a form of payment that has already been approved, then the process 100 may terminate. However, if there is at least one transaction corresponding to a form of payment that has already been approved, then process 100 may proceed to block 110.

In block 110, the payment server 16 may determine if the transaction corresponding to all approved forms of payment may be reversed or refunded based on the business rules stored in the rules database 20. If the approved form or forms of payment are not reversible or refundable, then process 100 may terminate. However, if at least one approved form of payment is capable of being reversed or refunded, then the process 100 may proceed to block 112.

In block 112, the delivery server 28 may generate and send one or more rollback requests to one or more payment providers 18. Specifically, the delivery server may generate a rollback request for each transaction that has already been approved, where the rollback request is sent to a specific payment provider system 18. It is to be appreciated that the rollback requests may be sent to a corresponding one of the payment providers 18 asynchronously. The process 100 may then proceed to block 114.

In block 114, the delivery server 28 may determine one or more processing queues. The processing queue may include one or more rollback requests that each correspond to an approved form of payment. There may be separate processing queues for each specific type of merchant, as well as separate processing queues based on whether the form of payment is reversed or refunded. The process 100 may then proceed to block 116.

In decision block 116, the delivery server 28 determines if all reversal or refund notifications have been received for each rollback request within the predetermined amount of time. If all reversal or refund notifications are received by the delivery server 28, then the process 100 may terminate. However, if one or more reversal or refund notifications are not received within the predetermined amount of time, then the process 100 may proceed to block 118.

In block 118, the delivery server 28 may periodically send secondary requests corresponding to each rollback request that has not received a reversal or refund notification. Process 100 may then proceed to block 120.

In decision block 120, the delivery server 28 may continue to send a predetermined number of secondary requests to the particular payment provider system 18 at predetermined intervals of time until the delivery server 28 receives a reversal or refund notification from each rollback request. The process 100 may then terminate. In at least some instances, the delivery server 28 may not receive the reversal or refund notification after the predetermined number of secondary requests have been sent, and the process 100 may proceed to block 122.

In block 122, the delivery server 28 may place the remaining rollback requests that have not received a corresponding reversal or refund request into the timeout exception queue. As mentioned above, the rollback requests placed into the timeout exception queue require manual action. The process 100 may then terminate.

Referring generally to the figures, the disclosed system allows for an enhanced payment experience for a user, and also improves computer-related technology by allowing computer performance of a function not previously performable by a computer. That is, the disclosed system improves computer-related technology by allowing a computer to generate one or more rollback requests to reverse or refund an approved payment in response to another form of payment failing. Specifically, if one of the forms of payment has failed, then the disclosed system may generate a rollback request that reverses or refunds any payments that have already been approved, and the travel reservation is not booked. In contrast, conventional systems may still charge a traveler for a portion of the price of a travel reservation. This is because conventional systems are unable to reverse or refund any forms of payment that have already been approved. Instead, a travel representative may need to troubleshoot the payment transaction in order to reverse or refund an approved transaction.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow charts, sequence diagrams, and/or block diagrams.

In certain alternative embodiments, the functions, acts, and/or operations specified in the flow charts, sequence diagrams, and/or block diagrams may be re-ordered, processed serially, and/or processed concurrently consistent with embodiments of the invention. Moreover, any of the flow charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system comprising:
one or more processors; and
a memory coupled to the one or more processors, the memory storing data comprising program code that, when executed by the one or more processors, causes the system to:
receive information indicating a first form of payment, a first transaction to the first form of payment, information indicating a second form of payment, and a second transaction to the second form of payment that are collectively used to purchase a product or service;
send a first request to authorize the first transaction to the first form of payment to a first payment provider system;
receive a first notification that the first request has been approved by the first payment provider system;
send a second request to authorize the second transaction to the second form of payment to a second payment provider system;
detect a failure of the second request; and
in response to detecting the failure of the second request:
determine whether the first transaction to the first form of payment is capable of being reversed or refunded based on business rules; and
in response to determining that the first transaction to the first form of payment is capable of being reversed or refunded, send a first rollback request to the first payment provider system with instructions to reverse or refund the first transaction.

2. The system of claim 1 wherein the program code, when executed by the one or more processors, further causes the system to:
receive information indicating a third form of payment and a third transaction to the third form of payment that are further used to purchase the product or service;
send, to a third payment provider system, a third request to authorize the third transaction to the third form of payment; and
receive a second notification that the third request has been approved by the third payment provider system.

3. The system of claim 2 wherein the program code, when executed by the one or more processors, further causes the system to:
send a second rollback request to the third payment provider system with instructions to reverse or refund the third transaction,
wherein the first rollback request and the second rollback request occur asynchronously with respect to one another.

4. The system of claim 3 wherein the first rollback request and the second rollback request are placed in a processing queue, and the first rollback request is removed from the processing queue after receiving a reverse notification or a refund notification.

5. The system of claim 1 wherein a refund notification is not received in reply to the first rollback request over a predetermined amount of time, and the program code, when executed by the one or more processors, further causes the system to:
periodically send a predetermined number of secondary requests for reversal or refund of the first transaction to the first payment provider system at predetermined intervals of time.

6. The system of claim 5 wherein the program code, when executed by the one or more processors, further causes the system to:
in response to the predetermined number of the secondary requests failing to result in receipt of a reverse or refund notification, place the first transaction into a timeout exception queue.

7. The system of claim 1 wherein instructions for the first rollback request include an instruction to reverse the first transaction.

8. The system of claim 1 wherein instructions for the first rollback request include an instruction to refund the first transaction.

9. The system of claim 1 wherein the program code, when executed by the one or more processors, further causes the system to detect the failure of the second request by:
receiving a second notification from the second payment provider that second request has been denied by the second payment provider.

10. A method comprising:
receiving, by a computer, information indicating a first form of payment, a first transaction to the first form of payment, information indicating a second form of payment, and a second transaction to the second form of payment that are collectively used to purchase a product or service;
sending, by the computer, a first request to authorize the first transaction to the first form of payment to a first payment provider system;
receiving a first notification that the first request has been approved by the first payment provider system;
sending, by the computer, a second request to authorize the second transaction to the second form of payment to a second payment provider system;
detecting a failure of the second request; and
in response to detecting the failure of the second request:
determining, by the computer, whether the first transaction to the first form of payment is capable of being reversed or refunded based on business rules; and
in response to determining that the first transaction to the first form of payment is capable of being reversed or refunded, sending a first rollback request, by the computer, to the first payment provider system with instructions to reverse or refund the first transaction.

11. The method of claim 10 further comprising:
receiving, by the computer, information indicating a third form of payment and a third transaction to the third form of payment that are further used to purchase the product or service;
sending, by the computer to a third payment provider system, a third request to authorize the third transaction to the third form of payment; and
receive a second notification that the third request has been approved by the third payment provider system.

12. The method of claim 11 further comprising:
sending, by the computer, a second rollback request to the third payment provider system with instructions to reverse or refund the third transaction,
wherein the first rollback request and the second rollback request occur asynchronously with respect to one another.

13. The method of claim 12 further comprising:
placing the first rollback request and the second rollback request in a processing queue; and
removing the first rollback request from the processing queue after receiving a reverse notification or a refund notification.

14. The method of claim 10 wherein a refund notification is not received in reply to the first rollback request over a predetermined amount of time, and further comprising:
periodically sending, by the computer, a predetermined number of secondary requests for reversal or refund of the first transaction to the first payment provider system at predetermined intervals of time.

15. The method of claim 14 further comprising:
in response to the predetermined number of the secondary requests failing to result in receipt of a reverse or refund notification, placing the first transaction into a timeout exception queue.

16. The method of claim 10 wherein instructions for the first rollback request include an instruction to reverse the first transaction.

17. The method of claim 10 wherein instructions for the first rollback request include an instruction to refund the first transaction.

18. The method of claim 10 wherein detecting the failure of the second request comprises:
receiving a second notification from the second payment provider that second request has been denied by the second payment provider.

19. A computer program product for selecting a travel record associated with a user profile, the computer program product comprising:
a non-transitory computer-readable storage medium; and
program code stored on the non-transitory computer-readable storage medium that, when executed by one or more processors, causes the one or more processors to:
receive information indicating a first form of payment, a first transaction to the first form of payment, information indicating a second form of payment, and a second transaction to the second form of payment that are collectively used to purchase a product or service;
send a first request to authorize the first transaction to the first form of payment to a first payment provider system;
receive a first notification that the first request has been approved by the first payment provider system;
send a second request to authorize the second transaction to the second form of payment to a second payment provider system;
detect a failure of the second request; and
in response to detecting the failure of the second request:
determine whether the first transaction to the first form of payment is capable of being reversed or refunded based on business rules; and
in response to determining that the first transaction to the first form of payment is capable of being reversed or refunded, send a first rollback request to the first payment provider system with instructions to reverse or refund the first transaction.
